(19) United States
(12) Patent Application Publication
(10) Pub. No.: US 2026/0139963 A1
(43) Pub. Date: May 21, 2026

(54) TRAFFIC SIGN BASED MAP GRAPH UPDATER

(71) Applicant: GM Global Technology Operations LLC, Detroit, MI (US)

(72) Inventor: Alireza Esna Ashari Esfahani, San Bruno, CA (US)

(21) Appl. No.: 18/951,976

(22) Filed: Nov. 19, 2024

(51) Int. Cl. G01C 21/00; G06V 20/58

(52) U.S. Cl. CPC G01C 21/3837; G06V 20/582

(57) ABSTRACT

A vehicle includes at least one imaging sensor. A controller is in communication with the at least one imaging sensor and includes a processor and a memory. The memory stores a sign reasoner module configured to receive a lane level map graph and an image generated by the at least one imaging sensor. The sign reasoner module is configured to identify a traffic flow message of a sign in the image and to update the lane level map graph based on the traffic flow message. The sign reasoner is a generative artificial intelligence (AI) and includes a connection to at least one external information source. The sign reasoner is configured to identify the traffic flow message based at least in part on a retrieval augmented generation analysis of the external information source.

The subject disclosure relates to vehicles, and in particular to a system for updating map graphs for vehicle systems based on detected signs and on external knowledge.

Vehicles including autonomous driving systems and driver assistance systems utilize map graphs to identify lanes in roadways, and plot transitions between lanes, across intersections, and the like. In some examples, the identification can be based on stored High Definition maps including lane level details (HD maps) or Medium definition maps including road level details (MD maps) combined with global navigation satellite (GNSS) systems and images provided by onboard imaging systems. However, in some cases the map graph is incomplete and/or cannot be made wholly complete based solely on the stored information. Similarly, in some cases the map graph is based on HD map data.

By way of example, construction zones with lane closures and merges are often not reflected in map graph databases or in HD maps that are used to generate map graphs on the fly due to their transitory nature. Similarly, intersections may have varying lane connections (e.g. right turn only lanes, turning into more than one possible lane, etc.) that are not delineated via road lines and are not stored within a map database. Exacerbating the difficulty of completing map graphs across intersections is the fact that lanes permitted to connect to other lanes may be dependent on which particular locale a vehicle is located in due to regional level traffic regulations.

Some vehicles do not use HD maps or MD maps and instead generate maps on the fly using only images received from one or more cameras. The methods used by these vehicles is referred to as an HD map free method. HD map free methods generate lane level maps and graphs on the fly and may contain errors due to the quality of the images received from the camera, occlusions (a big truck covers the view) or a particular topology such as lane merge is far away from the camera and is not captured.

Accordingly, it is desirable to provide a system for updating map graphs accounting for external knowledge of regional traffic regulations and text and images displayed via signage at or near a location where the map graph is incomplete. It is further desirable to generate complete and accurate map graphs on the fly based on image data generated by the vehicle using the map graph, thereby reducing a dependency on pre-computed data.

### SUMMARY

In one exemplary embodiment, a vehicle includes at least one imaging sensor. A controller is in communication with the at least one imaging sensor and includes a processor and a memory. The memory stores a sign reasoner module configured to receive a lane level map graph and an image generated by the at least one imaging sensor. The sign reasoner module is configured to identify a traffic flow message of a sign in the image and to update the lane level map graph based on the traffic flow message. The sign reasoner is a generative artificial intelligence (AI) and includes a connection to at least one external information source. The sign reasoner is configured to identify the traffic flow message based at least in part on a retrieval augmented generation analysis of the external information source.

In addition to one or more of the features described herein the sign reasoner module includes an extraction and tagging feature, a function caller feature, an external knowledge retrieval feature, a memory, a sign position feature, and a map graph generator.

In addition to one or more of the features described herein the extraction and tagging feature is configured to interpret at least one of a scenario, and maneuver, an attribute, a vehicle type exclusion, a time limit, and a lane vehicle type from the traffic flow message and an initial map graph.

In addition to one or more of the features described herein the sign reasoner module comprises one of a large language model (LLM).

In addition to one or more of the features described herein the LLM includes a relevance detection feature, and wherein the relevance detection feature is configured determined a relevance of the traffic flow message to the vehicle based on an output of the tagging and extraction feature, the image, and an initial map graph.

In addition to one or more of the features described herein the relevance detection feature is further configured to call at least one rules based function and wherein the at least one rules based function is configured to respond with supplementary data.

In addition to one or more of the features described herein the at least one rules based function includes a time and date function, an obstruction detection function, a scene information function, and a vehicle type function.

In addition to one or more of the features described herein the LLM further includes a map graph updater, and wherein the map graph updater is configured to update the initial map graph based on the image using at least one of a rules based map graph update process, a deep learning network graph generator (GNN) based map graph update process, and an LLM based map graph update process.

In addition to one or more of the features described herein the map graph updater is configured to update the initial map graph using each of the rules based map graph update process, the GNN update process, and the rules based map graph update process.

In addition to one or more of the features described herein an output of the map graph updater is provided to the memory as an updated map graph and wherein the memory is configured to retain the updated map graph while the relevance detection feature indicates that the traffic flow message is relevant to the vehicle.

In addition to one or more of the features described herein an output of the map graph updater is provided to at least on vehicle system and wherein the at least one vehicle system is configured to operate one of an autonomous vehicle function and a semi-autonomous vehicle functions based at least in part on the updated map graph.

In addition to one or more of the features described herein the updated map graph is specific to a context of the vehicle, the context of the vehicle including at least a vehicle type, a time of day, and an ambient lighting condition.

In addition to one or more of the features described herein the external knowledge retrieval feature is a retrieval augmented generation (RAG) configured to identify a traffic flow message of the sign and respond to the identified traffic flow message being incomplete by polling the external information and completing the traffic flow message using the external information.

In addition to one or more of the features described herein completing the traffic flow message using the external information comprises inferring missing information using contextual clues within the external information.

In addition to one or more of the features described herein completing the traffic flow message using the external information comprises identifying an express statement of the missing information within the external information and updating the traffic flow message with the expressly stated missing information.

In addition to one or more of the features described herein the lane level map graph is a maples map graph and is generated at least in part based on edge detection of the image.

In another exemplary embodiment a process for updating a map graph for a vehicle includes receiving an initial map graph and an image of a sign at a sign reasoner and determining a traffic flow message of the sign based at least in part on accessing an external information source using a retrieval augmented generation process. The initial map graph is updated to an updated map graph based on the traffic flow message and the initial map graph. The updated map graph is provided to at least one vehicle operation system. The at least one vehicle operation system is one of an autonomous vehicle operation and a semi-autonomous vehicle operation.

In addition to one or more of the features described herein updating the initial map graph to the updated map graph comprises using an extraction and tagging feature of a large language model to interpret at least one of a scenario, and maneuver, an attribute, a vehicle type exclusion, a time limit, and a lane vehicle type from the traffic flow message and the initial map graph.

In addition to one or more of the features described herein determining a relevance of the traffic flow message to the vehicle based at least in part on the initial map graph, the output of the retrieval augmented generation process, and an output of a rules based function call, and storing the updated map graph in a memory while the relevance of the traffic flow message is determined to be relevant, wherein the relevance is based at least in part on the determined time limit and lane vehicle type.

In addition to one or more of the features described herein the retrieval augmented generation process is configured to identify a traffic flow message of the sign and respond to the identified traffic flow message being incomplete by polling the at least one external information source and completing the traffic flow message using the external information.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a vehicle including a map graph verification and updating architecture;

FIG. 2 is a high level map graph updating process;

FIG. 3 is an example implementation of the map graph updating process of FIG. 2;

FIG. 4 is an example architecture for the map graph updating system of FIGS. 1-3;

FIG. 5 is a detailed implementation of the example architecture of FIG. 4; and

FIG. 6 is an implementation of the detailed architecture of FIG. 5 according to one example.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

As used herein a map graph refers to a directed graph formed as an intersection of finitely many simply connected and internally disjointed regions of a Euclidean plane. A map graph is a graph used to represent the physical environment, road network, and surroundings representing a map. The map graph typically includes nodes and edges, with each element representing different aspects of the driving environment. Alternative implementations may vary slightly from the implementation described herein and still fall within the umbrella of map graphs. Nodes represent road lane segments (part of a lane) and edges represent how lanes are connected and how a vehicle can move from a lane segment to another lane segment. Nodes and edges may have corresponding attributes such as speed limit, location of stop bar, location to yield, and like.

As used herein a controller refers to a system including a processor and a memory configured to implement a described function. The system can be a dedicated controller for the described function, a general controller including a module for performing the described function, a distributed network of processors and memories configured to work in conjunction to implement the described function, or any similar structure configured to implement the function.

In a general example, the map graph updating system and architecture described herein generates map graphs based on existing map data using a neural network and/or retrieves existing map graphs from a map graph source. A camera, or other image sensor, captures an image of a traffic flow sign and provides the image to the map graph updating system, and the map graph updating system accesses an external knowledge repository including rules and regulations about a current region in which the vehicle running the map graph updating system is traveling. The map graph updating system can also gather information about the environment in which the vehicle is driving. This includes information about time, date, objects on the road, information about the type of vehicle (bus, passenger car, truck, etc.)

The map graph updating system analyzes the image and/or text on the traffic flow sign to identify a traffic flow message. The map graph updating system then either verifies the existing map graph or identifies one of a gap in the existing map graph and an inconsistency between the traffic flow sign and the map graph. As used herein, a traffic flow sign is a subset of traffic signs that includes a message or communication indicative of a map graph feature. By way of example, a right turn only sign is a traffic flow sign, however a fasten your seatbelt sign is not a traffic flow sign.

In the case of an inconsistency, the map graph updating system assumes that any traffic flow information communicated by the sign supersedes any stored map graph information. The map graph updating system then updates the map graph using a combination of the analyzed image and the external knowledge and the updated map graph is stored for use by one or more vehicle systems.

In some examples, the updated map graph is provided to an external data storage and can be provided to or retrieved by other vehicles traveling in the same region. In such examples, the data includes contextual data such as the type of vehicle, the time the data was generated, the date the data was generated, object detections, and the like.

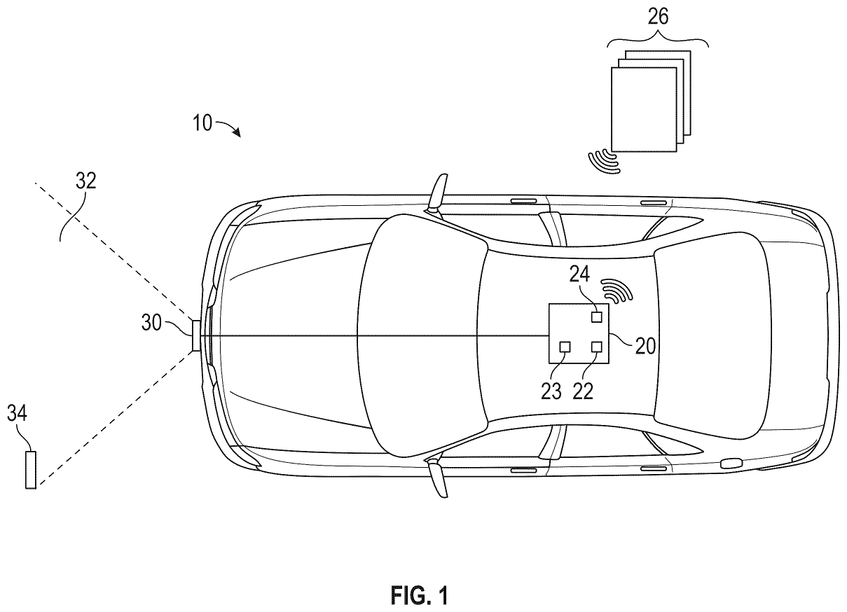

In accordance with an exemplary embodiment, FIG. 1 illustrates a vehicle 10. The vehicle 10 includes a controller 20 and an imaging sensor 30 in communication with the controller 20. The controller 20 includes a map graph updating architecture 22, a processor 23 and a memory 24 for storing map graphs and external information. In addition, the controller 20 is in communication with one or more external information sources 26. The communication can be direct via a cellular connection, or indirect through a cloud computing service or a large area network (e.g., the Internet). In some examples, in addition to storing some or all of the external information, the external information sources 26 may include processing resources able to operate in conjunction with the processor 23 to assist in processing one or more functions within the map graph updating architecture 22.

The imaging sensor 30 defines a field of view 32 able to detect and capture an image of a sign 34 ahead of the vehicle 10. In alternate examples, additional imaging sensors 30 may be utilized throughout the vehicle 10, and/or the imaging sensor 30 may be disposed at an alternate location on the vehicle 10 and function in a similar manner. Furthermore, the example of FIG. 1 is described with reference to a sign 34 ahead of the vehicle for the sake of expediency. In a practical implementation, the sign 34 may be at any position relative to the vehicle 10 when captured by the imaging sensor 30 and the map graph updating architecture 22 operations will remain the same.

In some examples, the controller 20 can further include a map graph generation module able to generate a map graph of a current road using lane lines and edge detection, and without using HD map data. This process is referred to as Maples map graph generation.

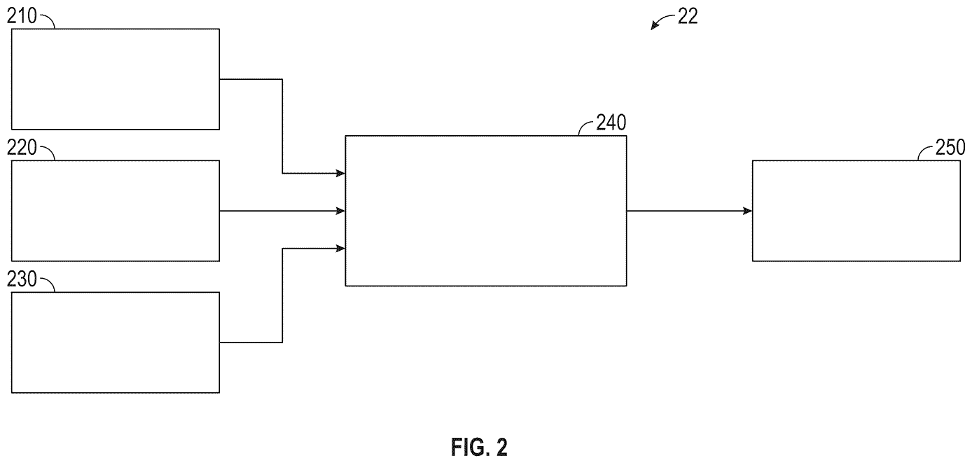

With continued reference to FIG. 1, FIG. 2 illustrates a high level process of operations of the map graph updating architecture 22. The general structure includes a sign reasoner 240 which receives a lane level map graph 210 of the road on which the vehicle 10 is currently traveling, any related external knowledge 220 for that road and/or the region in which the vehicle is currently traveling, and an image of the traffic flow sign 34, an extracted message from the traffic flow sign 34, or both the image and the extracted message from the traffic flow sign 34. The information from the traffic flow sign 34 is referred to as a traffic sign message 230.

In some examples, the traffic sign message 230 is extracted via a vision and language model analysis of the sign 34. Such examples are applied when the sign message is textual in nature and/or the sign 34 is not a standardized sign. In other examples, where the sign 34 is a standardized sign or includes standardized symbols, the information from the external knowledge 220 can be applied to extract the meaning of the symbols and traffic flow messages. For universal or well known symbols (e.g. a red octagon as a stop sign), the meaning of the sign may be extracted via classification. However, lesser known signs and/or vague and incomplete messages require the external knowledge 220 to properly interpret. Example of visual signs requiring the external knowledge can be a complicated visual sign that is rare, like warning of falling rocks. One primary usage of the external knowledge is when the sign message does not contain all info we need. By way of example, a sign stating simply “merge ahead” does not say where the merge is happening, or indicate which lane is merging. Similarly, a sign that says “right lane must turn right” does not indicate which lane the right lane should turn into.

The sign reasoner 240 uses the combined information to identify discrepancies and gaps in the map graph 210 and corrects the discrepancies or gaps. The corrected map graph is then output from the sign reasoner as an updated map graph 250. The updated map graph 250 is provided to any operating autonomous or semi-autonomous vehicle systems utilizing map graphs (e.g. a motion planner). In addition, the map graph 250 may be provided to the external information sources 26 or any other connected map graph repository, and stored for access by other vehicles or systems utilizing map graphs.

With continued reference to FIGS. 1 and 2, FIG. 3 illustrates an example operation of the architecture 22 as the vehicle 10 approaches an intersection 212, where the road is divided into lanes (L1, L3, L4, L6, L9 and L10) via lane lines and where the lane lines do not extend through the intersection 212. In the example operation, as the vehicle 10 approaches the intersection 212 a map graph of the intersection is generated using a deep learning network graph generator (GNN) based on the lane lines, and structure of the intersection 212 and edge detection in the image collected by the camera. In alternate examples the initial map graph 210 may be retrieved from a data source or generated using any alternate means of generation.

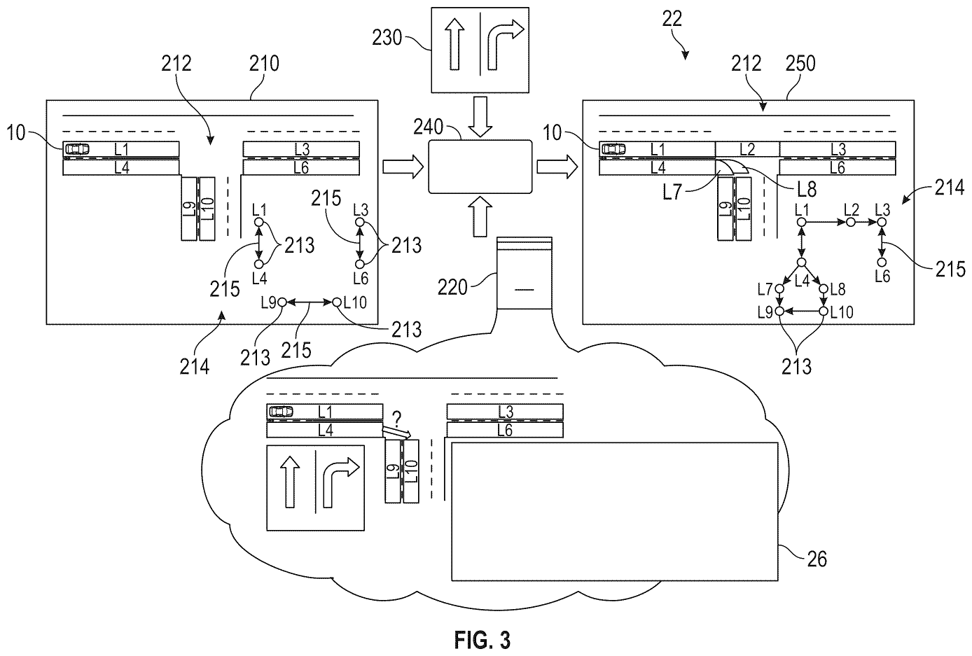

Due to the lack of lane lines extending through the intersection 212 the initially generated map graph 210 does not connect the lanes across the intersection 212. The illustration of FIG. 3 includes a top down schematic view of the intersection 212, and a data representation 214 of the map graph 210, with the data representation 214 indicating the features (lanes 213 and joints 215 where the lanes 213 may be traversed via lateral movement between lanes 213) identified on the map graph 210. The generated map graph 210 is provided to the sign reasoner 240.

In addition, the imaging sensor 30 on the vehicle 10 captures an image of a sign 230, and the image is provided to the sign reasoner 240. In the illustrated example, the sign 230 includes lane indicators demonstrating that a left lane (L1) is only permitted to connect straight through the intersection 212 and the right lane (L4) is only permitted to turn right at the intersection 212. As the sign 240 uses standardized symbology, the sign reasoner 240 uses a database of symbol interpretation to identify the meaning of the symbols included on the sign 230. In alternative examples, where the sign 34 uses text to communicate the permitted traffic flow (e.g., a construction lane closure or detour sign), the sign reasoner 240 interprets the text on the sign 230 using a large language model (LLM) or similar machine learning structure. By way of example, the similar machine learning structure could include a generative artificial intelligence (Gen AI) structure.

Based on the gap at the intersection 212 and the traffic flow message of the sign 230, the sign reasoner 240 can determine that L1 connects through to L3, via a lane segment L2, where L2 needs to be created and to be added to the graph. However, lane L4 could turn right into either lane L9 (via a lane segment L7) or lane L10 (via a lane segment L8). Which lane segment L7, L8 or both may be utilized is region dependent. By way of example, in some states it is permissible for a vehicle in lane L4 to turn into lane L10 however in other states it is only permissible for the vehicle in lane L4 to turn into lane L9. In order to make this determination, the sign reasoner 240 accesses the external information sources 220, including the remote system 26. The external information sources 220 include codes and regulations for various regions and municipalities, and the sign reasoner 240 analyzes the codes and regulations using an LLM to determine the correct connections for the lanes L1 and L4 through the intersection 212.

Once the correct connections are determined, the sign reasoner 240 outputs the updated map graph 250, including the full set of lanes 213 and joints 215, and the output map graph 250 is provided to a planner module of one or more additional systems within the vehicle 10 as described above.

With continued reference to FIGS. 1-3, FIG. 4 illustrates an example architecture 400 of the sign reasoner 240. The sign reasoner 240 includes a large language model (LLM 410) machine learning network trained to include an extracting and tagging feature module 412 for interpreting the traffic flow sign 34 and a function caller module 414 for calling and performing predefined functions 420 used in data gathering to assist the LLM. By way of example, the predefined functions 420 can include a node generator function 422 configured to generate new nodes for the new map graph (e.g. L2, L7, and L8 of FIG. 3), a time/date function 424 configured to provide the current time/date to the LLM 410, a barrier detection function 426 configured to identify cones, barriers and other obstructions across the road based on the images captured by the imaging sensor 30, a query scene information function 428 for identifying information regarding the surrounding environment, and a query vehicle type function 430 for identifying a type of the vehicle 10. Each of the functions 420 operates using predefined computer code and module connections and are not machine learning based. The functions 420 can be performed according to any conventional process for performing a defined function 420. Furthermore, alternative implementations may include a subset of these functions 420 and/or additional functions 420 depending on the details of that particular implementation.

In some examples, where the graph node is being stored for future use and/or being provided to other vehicles, the LLM 410 may include an optional transitory detection function 411. The optional transitory detection function 411 determines whether the sign 34 is permanent in nature, such as a right turn only sign, or transitory in nature, such as with a construction lane merge sign. Based on this determination, a graph generation feature 440 can determine whether to store the update map graph for future use, or limit application of the updated map graph to the current operations of the vehicle 10. In addition, the graph generation feature 440 applies contextual data to the map as meta data. The contextual data defines the scope of the map such that, if stored for use by other vehicles, the map is only applied by similar vehicles in a similar situation (e.g., vehicles matching a certain threshold of the stored context).

A sign position feature 442 identifies where the sign 34 is relative to the map graph 210 and determines where the information provided on the sign 34 should be applied to the map graph 210. By way of example, a lane closed ahead sign indicates a closure of one of the lanes, and the sign position feature identifies where the lane is closed on the map graph 210. By way of example, the determination may be based on a longitudinal direction of the vehicle, which lane the vehicle is in, other traffic ques, information included on the sign (e.g. 200 ft. ahead), and the like.

The LLM 410 further includes a memory 418 for temporarily storing information during the operation of the sign reasoner 240 and a retrieval augmented generator (RAG) 416 for interfacing with, and retrieving information from, the external knowledge source 26.

A graph generation feature 440 generates the final map graph 250 based on the full operations of the LLM 410 and outputs the final map graph to the one or more systems that will utilize the map graph 250.

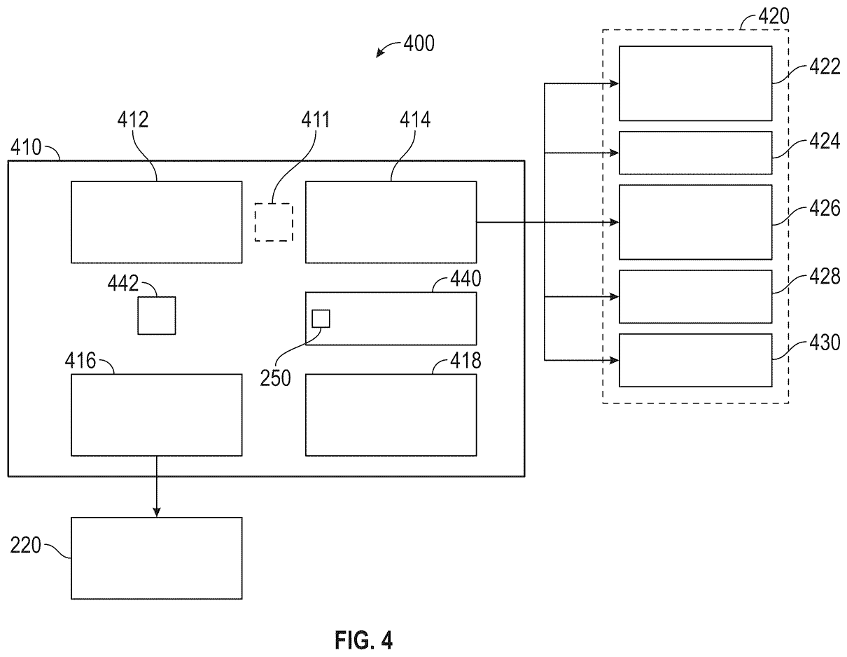

With continued reference to FIGS. 1-4, FIG. 5 illustrates a detailed process flow utilizing the example architecture of FIG. 4 according to one implementation 500 with arrows 505 interconnecting various modules and indicating a general direction of data flow. It is appreciated that the general direction of data flow indicated by the arrows 505 is not limiting, and certain modules or features may communicate with and exchange data with other modules and features even when such is not explicitly indicated via the data flow arrows 505.

In the detailed implementation, an initial sign message 501 and an initial map graph 503 are provided to the extraction and tagging feature 412. Using the sign message 501 the extraction and tagging feature identifies a scenario 502, a maneuver and direction of the vehicle 10 (maneuver 504), applicable attributes 506, vehicle type exclusions 508, time limits 510, and lane vehicle types 512 and provides the extracted information to the LLM 410. In alternate examples additional features may be extracted within the extraction and tagging feature 412 and provided to the LLM 410 (illustrated in FIG. 4).

The scenario 502 identifies what operation is being encountered. By way of examples, scenarios can include merges, intersections, 4-way intersections, lane closures, lane obstructions (e.g. a disabled vehicle), T-intersections, and the like.

The maneuver 504 identifies the direction of travel the vehicle 10 needs to follow to execute the traffic flow message as well as any specific factors that limit or otherwise impact the execution of the traffic flow message (e.g. a right turn only limitation that is only applied to the rightmost lane)

The attribute detection 506 identifies any pertinent attributes for the traffic flow information contained in the sign message 510. By way of example, the pertinent information can include a speed limit, a yield instruction, a stop instruction, and the like. In some examples, the attribute detection can further detect whether the traffic flow message contained in the sign message 501 is transitory (e.g. temporary construction) or permanent in nature.

The vehicle type exclusions 508 determine whether any features included within the sign message apply to only certain vehicles (e.g. bus lanes, heavy truck exclusions, and the like).

The time limits 510 determine any time limits that apply to the sign message 501. By way of example, the time limits may include weekend exceptions, daytime exceptions, school hours exceptions, or any other time that limits when the traffic flow information contained within the sign message 501 is applicable.

The lane vehicle type detection 512 identifies limitations for specific lanes (e.g. bus lanes, high occupancy vehicle lanes, bike lanes, etc.) that restrict what types of vehicles may operate in that lane.

The data from the extraction and tagging feature 412 is obtained by the LLM 410, and the LLM 410 determines the relevance of any extracted information in a relevance step 550.

Based on the extracted information, the relevance step 550 determines whether the extracted traffic flow information (e.g. a lane merge) is currently relevant to the vehicle 10.

After determining the relevance of the traffic flow message to the vehicle 10, the LLM 410 uses the function caller 414, and the RAG 416, to operate the functions 420 and information retrieval using the RAG 416 at step 560. The functions 420 collect additional information including the current time, current date, type of vehicle 10, road obstructions, scene information, longitudinal location 522 where the change in the map graph should apply, which lane to turn into 524, a lateral location 526 where the change in the map graph should be applied, applicable traffic rules 528 and the like.

The graph updater 440 and the RAG 416 receive the sign message, the initial map graph, and any additional information retrieved by the functions 420 and the RAG 416 and updates the map graph based on the traffic flow information. The map graph update process uses a combination of rules based map graph updates 542, graph neural network (GNN) based map graph updates 544, and LLM based map graph updater 546. Initially, the graph updater 440 uses the rules based updates 542 apply a set of rules based on known information to update the map graph.

Subsequently, a GNN is applied to the graph and any image information of the lane lines captured by the imaging sensor 30 on the vehicle 10 are used to create new news and/or update attributes of the nodes. The GNN extrapolates as much map graph data as possible from the painted lines, construction barrels, guard rails, and other visible features of the road itself.

Once the final updated map graph is verified by the LLM 546, the updated map graph is stored in the memory 418 at a store updated graph step 570, until the LLM 410 determines that the map graph is currently relevant using the function caller 414.

In alternate examples, one or two of the map generation features (the rules based generator 542, the GNN based generator 544 and the LLM based generator 546) may be omitted, and the general function of the system may be maintained.

In some examples, the relevance of the map graph is maintained in the memory 418 until the vehicle 10 has traveled a predetermined distance beyond a point at which the sign is relevant. In one particular example, a lane merge sign indicating that the lane merges in 200 ft. may result in a generated map graph that is maintained until 300 feet beyond the sign (100 feet beyond the merge point). In an alternative example, the map graph is maintained until the merge has ended, as determined by the imaging sensor 30.

Prior to the vehicle 10 reaching the point where the map graph becomes relevant, the map graph is provided to a planner module in a map graph output step 580. The planner module uses the map graph according to any standard utilization for operating an autonomous or semi-autonomous vehicle operation.

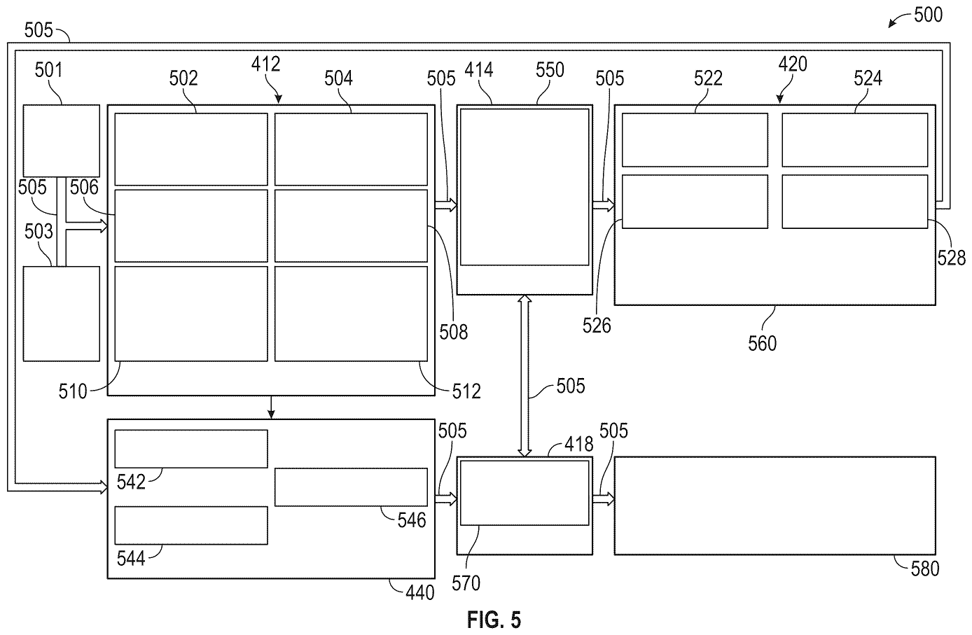

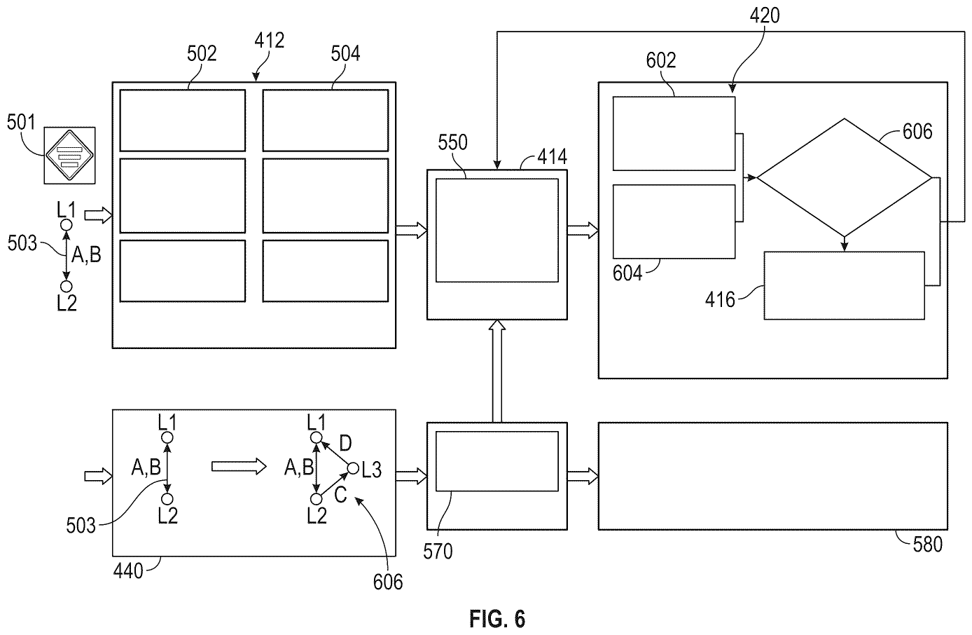

With continued reference to FIGS. 1-5, FIG. 6 illustrates an example operation of the implementation illustrated in FIG. 5 when the sign message 501 is a “right lane closed 1500 FT” sign. In the example of FIG. 6 it is appreciated that the structure is the same as FIG. 5.

Within the extraction and tagging feature module 412, the traffic flow message identified on the sign is “A lane merge between the rightmost lane and the immediately adjacent lane occurs 1500 feet from this point.” Based on this traffic flow message, the scenario is extracted as being a merge scenario 502, with a maneuver 504 on the right side of the vehicle 10. No other information is included within the traffic flow message. The extracted information is provided to the function caller 414 which determines that the sign is relevant to the vehicle 10 by calling functions 420.

In the example of FIG. 6, the relevance feature 414 determines that the longitudinal location of the merge relative to the vehicle 10 and the lateral location of the merge relative to the vehicle 10 are required to determine if the updated map graph is relevant. The relevance step 550 then calls functions 420 to determine the appropriate information. The functions 420 called include a longitudinal location function 602 which determines that the traffic flow message applies 1500 feet from the location of the sign message 501, and a lateral location function 604 which determines that the traffic flow message applies to the right of the vehicle 10.

In addition, the functions 420 includes determining a check 606 for any information that is not present in the sign message 501 and using the RAG 416 to search a relevant traffic manual for the pertinent information. By way of example, when the right lane close ahead sign omits a distance, the RAG 416 can poll the traffic sign manual to determine which (if any) regulations apply to the current sign. In the case that a regulation is pertinent (e.g. lane closed signs are to be placed 500 feet ahead of the closure), the information is identified through the RAG 416 search. The identified information is provided back to the relevance module 414 which then determines whether the sign 501 is relevant to the current map graph.

In some examples, the information needed is directly mentioned within the external knowledge 220. By way of example, the external knowledge 220 may state explicitly that “merge signs are installed 500 feet before a merge”.

In alternate examples, the external knowledge 220 does not directly state the missing information, and the information is inferred using the LLM 410. By way of example, the external knowledge 220 may include statements indicating that a merge sign is to be installed at a position able to provide the driver 14 to 14.5 second of vehicle maneuvers prior to the merge. Based on this time, and additional information (e.g. speed limits, direction and severity of the maneuver, etc.) the distance from the sign to the merge point is inferred by the LLM 410.

In yet further examples, the LLM 410 may utilize multiple distinct statements from different points throughout the external knowledge to construct the inference and the LLM 410 is not limited to identifying or relying on single statements to provide the context.

The map graph updater 440 updates the map graph to account for the lane merge using any of the map graph generation techniques and provides the updated map graph 606 to the memory 418 where the map graph is retained for the predetermined period. While stored in the memory, the updated map graph 606 is published to (made available to) any planner module for an autonomous or semi-autonomous vehicle system.

In some other, the processing for operating the sign reasoner 240 can be performed fully within the vehicle controller 20. In other examples, the processing may be split between the controller 20 and an external controller or performed entirely by the external controller, and still fall within the systems described herein.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A vehicle comprising:
at least one imaging sensor;
a controller in communication with the at least one imaging sensor, the controller including a processor and a memory, the memory storing a sign reasoner module configured to receive a lane level map graph and an image generated by the at least one imaging sensor and configured to identify a traffic flow message of a sign in the image and to update the lane level map graph based on the traffic flow message; and
wherein the sign reasoner module is a generative artificial intelligence (AI) and includes a connection to at least one external information source and wherein the sign reasoner module is configured to identify the traffic flow message based at least in part on a retrieval augmented generation analysis of the external information source.

2. The vehicle of claim 1, wherein the sign reasoner module includes an extraction and tagging feature, a function caller feature, an external knowledge retrieval feature, a memory, a sign position feature, and a map graph generator.

3. The vehicle of claim 2, wherein the extraction and tagging feature is configured to interpret at least one of a scenario, a maneuver, an attribute, a vehicle type exclusion, a time limit, and a lane vehicle type from the traffic flow message and an initial map graph.

4. The vehicle of claim 3, wherein the sign reasoner module comprises a large language model (LLM).

5. The vehicle of claim 4, wherein the LLM includes a relevance detection feature, and wherein the relevance detection feature is configured determined a relevance of the traffic flow message to the vehicle based on an output of the tagging and extraction feature, the image, and an initial map graph.

6. The vehicle of claim 5, wherein the relevance detection feature is further configured to call at least one rules based function and wherein the at least one rules based function is configured to respond with supplementary data.

7. The vehicle of claim 6, wherein the at least one rules based function includes a time and date function, an obstruction detection function, a scene information function, and a vehicle type function.

8. The vehicle of claim 5, wherein the LLM further includes a map graph updater, and wherein the map graph updater is configured to update the initial map graph based on the image using at least one of a rules based map graph update process, a deep learning network graph generator (GNN) based map graph update process, and an LLM based map graph update process.

9. The vehicle of claim 8, wherein the map graph updater is configured to update the initial map graph using each of the rules based map graph update process, the GNN update process, and the rules based map graph update process.

10. The vehicle of claim 8, wherein an output of the map graph updater is provided to the memory as an updated map graph and wherein the memory is configured to retain the updated map graph while the relevance detection feature indicates that the traffic flow message is relevant to the vehicle.

11. The vehicle of claim 10, wherein an output of the map graph updater is provided to at least one vehicle system and wherein the at least one vehicle system is configured to operate one of an autonomous vehicle function and a semi-autonomous vehicle functions based at least in part on the updated map graph.

12. The vehicle of claim 11, wherein the updated map graph is specific to a context of the vehicle, the context of the vehicle including at least a vehicle type, a time of day, and an ambient lighting condition.

13. The vehicle of claim 11, wherein the external knowledge retrieval feature is a retrieval augmented generation (RAG) configured to identify a traffic flow message of the sign and respond to the identified traffic flow message being incomplete by polling the at least one external information source and completing the traffic flow message using the external information.

14. The vehicle of claim 11, wherein completing the traffic flow message using the at least one external information source comprises inferring missing information using contextual clues within external information.

15. The vehicle of claim 11, wherein completing the traffic flow message using the external information comprises identifying an express statement of missing information within the at least one external information source and updating the traffic flow message with the expressly stated missing information.

16. The vehicle of claim 1, wherein the lane level map graph is a Maples map graph and is generated at least in part based on edge detection of the image.

17. A process for updating a map graph for a vehicle comprising:
receiving an initial map graph and an image of a sign at a sign reasoner;
determining a traffic flow message of the sign based at least in part on accessing an external information source using a retrieval augmented generation process;
updating the initial map graph to an updated map graph based on the traffic flow message and the initial map graph; and
providing the updated map graph to at least one vehicle operation system, the at least one vehicle operation system being one of an autonomous vehicle operation and a semi-autonomous vehicle operation.

18. The process of claim 17, wherein updating the initial map graph to the updated map graph comprises using an extraction and tagging feature of a large language model to interpret at least one of a scenario, and maneuver, an attribute, a vehicle type exclusion, a time limit, and a lane vehicle type from the traffic flow message and the initial map graph.

19. The process of claim 18, further comprising determining a relevance of the traffic flow message to the vehicle based at least in part on the initial map graph, an output of the retrieval augmented generation process, and an output of a rules based function call, and storing the updated map graph in a memory while the relevance of the traffic flow message is determined to be relevant, wherein the relevance is based at least in part on the time limit and lane vehicle type.

20. The process of claim 17, wherein the retrieval augmented generation process is configured to identify a traffic flow message of the sign and respond to the identified traffic flow message being incomplete by polling the at least one external information source and completing the traffic flow message using the external information.
